(19) United States
(12) Patent Application Publication
(10) Pub. No.: US 2017/0281465 A1
(43) Pub. Date: Oct. 5, 2017

(54) APPARATUS FOR PROMOTING INEFFECTIVE SWEATIING

(71) Applicants: CORONA CORPORATION, Sanjo-shi, Niigata (JP); Koyo Corporation, Miyaki-gun, Saga (JP)

(72) Inventors: Kenji TAKAO, Saga (JP); Kazunori SUDA, Niigata (JP); Yoshiji TOKITA, Niigata (JP); Katsumi MOROGA, Niigata (JP)

(21) Appl. No.: 15/508,852

(22) PCT Filed: Jan. 7, 2016
(86) PCT No.: PCT/JP2016/050347

§ 371 Date: Mar. 3, 2017

(30) Foreign Application Priority Data
Oct. 20, 2015 (JP) 2015-206598

(51) Int. Cl. A61H 33/06

(52) U.S. Cl. CPC A61H 33/063; A61H 33/066; A61H 2230/505; A61H 2201/0207

(57) ABSTRACT

To provide an apparatus for promoting ineffective sweating includes an air heating unit for heating air in a sweating room, a mist generator for generating mist, a blower for circulating air in the sweating room by supplying mist, and a control device. The sweating room is provided with a temperature sensor and a humidity sensor for measuring temperature and relative humidity respectively in the sweating room. The control device is provided with a dew-point temperature determination unit for determining a dew-point temperature td in the sweating room based on the temperature and the relative humidity and a temperature setting unit for setting a body temperature of a user, and controls the air heating unit and the mist generator so that the dew-point temperature td is kept higher than the body temperature. This configuration can promote comfortable ineffective sweating with the low physical burden on the user.

### BACKGROUND OF THE INVENTION

### Field of the Invention

The present invention relates to an apparatus for promoting ineffective sweating, particularly to provide patients receiving treatment of chronic hemodialysis (hereinafter referred to as dialysis) with the apparatus for promoting ineffective sweating in consideration of physical burden due to sweating for eliminating a risk of developing congestive heart failure.

### Discussion of the Background

Patients with renal failure whose renal functions are deteriorated is required by the dialysis using artificial kidneys to discharge excess water in their bodies in order to, first, remove end products (nephrotoxic substances) of protein, second, correct electrolyte imbalance, third, cure an overhydrated state caused by decrease in or absence of urine production.

Remarkable development of artificial kidney related devices has made it possible to remove nephrotoxic substances such as BUN and Cr to approximately a normal level or lower in a snort time, however regarding overhydration, no other solutions other than the dialysis treatment have been found yet.

With reference to FIG. 12, a relationship in the dialysis patient between the dialysis treatment and the excess amount of water in a body (an increased water amount relative to an appropriate water amount in an appropriate standard weight of a dialysis patient) will be described. FIG. 11 is a graph showing a conventional transition or the weight of the dialysis patient every day of the week, in which a vertical axis indicates the excess water amount (kg) in the body and a horizontal axis indicates an elapse of every day of the week (day).

Dialysis is generally required every other day, and is performed such as on Monday/Wednesday/Friday or Tuesday/Thursday/Saturday taking around 6 hours per one treatment as shown in FIG. 12, however there have been many medical facilities in which the dialysis treatment cannot be performed on Sunday for unavoidable reasons such as schedules of staff in charge of dialysis treatment in a hospital.

Thus, if dialysis cannot be performed for two days including Sunday, water accumulates more than a dialysis performed every other day so that a risk of developing congestive heart failure is increasing gradually until Monday morning (A part indicated by the hatching of FIG. 12 shows the excess water amount).

In order not to reach such a condition, the dialysis patients are compelled to lead under a severe living environment where they need to restrict intake of water extremely from Sunday to Monday.

Dialysis removes water aiming at standard weights of individual patients which are previously set, however water amount in the bodies increase gradually after dialysis due to absence of urine production.

FIG. 12 created based on data shows the weight is increased to be 2.1 kg (water amount: 2,100 ml) heavier than the standard weight in the dialysis treatments performed every other day (dialysis intervals: 42 hours) based on the data. If there are two days between each of the dialysis treatments (the dialysis intervals: 66 hours), the weight is increased to be 3.15 kg (water amount: 3,150 ml), heavier than the standard weight, thus the water amount increasing on Saturday and Sunday, namely, 3,150 ml minus 2,100 ml equals 1,050 ml, may increase a risk of congestive heart failure. (Variations of the water amount in the body are based on the data constituted of 58 adult males and 31 adult females, 89 in total.)

On the other hand, it is known that the sweating is usually promoted by taking a bath in a bathtub creating a thermal feeling to warm the body, a high temperature dry sauna apparatus and a moderate temperature mist sauna apparatus or the like (for example, Patent Literature 1 or the like).

### CITATION LIST

Patent Literature 1: Japanese Unexamined Patent Application Publication No. 2005-52287

### SUMMARY OF THE INVENTION

### Technical Problem

However, in bathing and a moderate high temperature sauna or the like, water pressure and room temperature are too high to sustain a preferable ineffective sweating environment, so that a burden on a user is increased. Thus, it has been almost impossible due to the heat in a sauna room for physically weak people such as dialysis patients who are suffering from congestion in their lungs usually all the time and have loads in breathing and their hearts to use the bathing and the sauna of moderate high temperature.

Here, a sweating which lowers a body temperature by vaporization heat generated when sweat is evaporated is referred to as effective sweating, while the ineffective sweating refers to a sweating which doesn't lower the body temperature because sweat is formed as droplet without being evaporated to become beads of sweat.

The present invention is made in view of such backgrounds and intended to provide an apparatus for promoting ineffective sweating with a low physical burden on the user to promote comfortable ineffective sweating, especially, which is used easily by the physically weak people such as the dialysis patients.

### Solution to Problem

In order to solve the foregoing problem, the invention according to claim 1 provides an apparatus for promoting ineffective sweating including:

a sweating room for accommodating a user; an air heating unit for heating the air of the sweating room; a mist generator for generating mist (nano-mist) including negative air ions; a blower for supplying the mist in the sweating room to circulate the air in the sweating room; and control device for controlling operation, further including:

a temperature sensor for measuring an air temperature in the sweating room; and a humidity sensor for measuring a relative humidity in the sweating room, a dew-point temperature determination unit for determining a dew-point temperature in the sweating room based on the room temperature and the relative humidity, and a body temperature setting unit for setting a body temperature of the user, and wherein the control device controls the air heating unit and the mist generator so that the dew-point temperature determined by the dew-point temperature determination unit is kept higher than the body temperature.

With such a configuration, the apparatus for promoting ineffective sweating according to the present invention is provided with the body temperature setting unit for setting the body temperature of the user so that the body temperature of the user is set appropriately, and that a suitable dew-point temperature at which the burden on the user is low based on the body temperature of the user is determined.

Further, the air heating unit and the mist generator are controlled such that the dew-point determined by the dew-point temperature determination unit is kept higher than the body temperature, so that it is possible to keep the dew-point in the sweating room is a little higher than the body temperature, resulting in controlling the sweating room to be comfortable environment in which ineffective sweating can be promoted with the low physical burden on the user.

As such, the apparatus for promoting ineffective sweating according to the present invention is capable of promoting the comfortable ineffective sweating even for the physically weak people such as the dialysis patients so as to prevent them from becoming in the overhydrated state by regulating the water amount in the body preferably.

The invention according to claim 2 of the present invention is the apparatus for promoting ineffective sweating described in claim 1, wherein

the body temperature setting unit determines the body temperature of the user to be either a measured either temperature input by a user or a deemed temperature.

Thus, the invention according to claim 2 sets the either temperature input by the user or the deemed temperature preset as the body temperature of the user so as to appropriately set the body temperature of the user with a simple configuration.

The measured temperature in the user is set in such a way the user inputs before using the apparatus for promoting ineffective sweating in view of conditions of sauna bathing or the like. The deemed temperature can be preset as an initial setting condition in such a way the user considers use conditions or the like.

The invention according to claim 3 is the apparatus for promoting ineffective sweating described in claim 1 or claim 2, wherein the control device controls the air heating unit to keep the room temperature equal to the preset temperature in a range from 37 to 42 degrees C. input by the user, and controls the mist generator to regulate the relative humidity in the sweating room based on the preset temperature so that the dew-point temperature is kept higher than the body temperature.

Thus, the invention according to claim 3 regulates the relative humidity in the sweating room, in the room temperature in a range from 37 to 42 degrees C. preset according to the preference of the user, so that the dew-point temperature is kept higher than the body temperature so as to provide the comfortable ineffective sweating environment widely for the physically weak people and even users who prefer thermal feeling.

The invention according to claim 4 is the apparatus for promoting ineffective sweating described in any one of claim 1 to claim 3, wherein the dew-point temperature determination unit determines the dew-point temperature by a dew-point temperature calculation expression or a dew-point temperature table preset based on the room temperature and the relative humidity.

With such a configuration, the invention according to claim 4 reads to a storage device and the like the dew-point temperature calculation expression set by using an empirical formula or the like in view of the use conditions of the sweating room or the like, and the dew-point temperature table created based on the room temperature found by the dew-point temperature calculation expression and the relative humidity so as to find the dew-point temperature.

The invention according to claim 5 is the apparatus for promoting ineffective sweating described in claim 1 or claim 2, wherein the control device controls the air heating unit and the mist generator so that the dew-point temperature is kept higher than the body temperature and a difference between the body temperature and the dew-point temperature is within a preset temperature.

Thus, the invention according to claim 5 controls the air heating unit and the mist generator so that the difference between the body temperature and the dew-point temperature is within the predetermined temperature so as to lower the dew-point temperature and to promote the comfortable ineffective sweating with the low physical burden on the user.

As such, the apparatus for promoting ineffective sweating according to the present invention is capable of promoting preferable ineffective sweating for the dialysis patients so as to regulate the water amount in the body appropriately to be capable of surely preventing the overhydrated state.

### Advantageous Effects of the Invention

The apparatus for promoting ineffective sweating according to the present invention is capable of promoting the comfortable ineffective sweating with the low physical burden on the user. Since it is possible to surely prevent the overhydrated state by regulating appropriately the water amount in the body with the low physical burden on the dialysis patient, the apparatus for promoting ineffective sweating can be especially preferably used for the dialysis patients them.

### BRIEF DESCRIPTION OF THE DRAWINGS

The present invention is described in detail below with reference to the attached drawing figures, wherein:

FIG. 1 is a front view showing an external appearance of the apparatus for promoting ineffective sweating according to the embodiment of the present invention

FIG. 2 is a sectional front view showing the configuration of the mist generator according to the embodiment of the present invention

FIG. 3 is a sectional side view showing the configuration of the mist generator according to the embodiment of the present invention

FIG. 4 is a plane view showing the configuration of the mist generator according to the embodiment of the present invention

FIG. 5 is a block diagram showing the configuration of the control device according to the embodiment of the present invention

FIG. 6 is a table showing the dew-point temperature table for illustrating the action of the apparatus for promoting ineffective sweating according to the embodiment of the present invention

FIG. 7 is a graph showing the changes of the body temperature and the elapsed time for illustrating the effects of the apparatus for promoting ineffective sweating according to the embodiment of the present invention

FIG. 8 is a graph showing the transitions of the heat absorbing velocity and the elapsed time for illustrating the effects of the apparatus for promoting ineffective sweating according to the embodiment of the present invention

FIG. 9 is a graph showing the transitions of the integrated heat amount and the elapsed time for illustrating the effects of the apparatus for promoting ineffective sweating according to the embodiment of the present invention

FIG. 10 is a graph showing the transitions of the body temperature and the elapsed time for illustrating how to use the apparatus for promoting ineffective sweating according to the embodiment of the present invention.

FIG. 11 is a graph showing the effects of the apparatus for promoting ineffective sweating according to the embodiment of the present invention, wherein the relationship between the transition of the excess water amount in the body of the dialysis patient and the dialysis treatment is shown.

FIG. 12 is a graph showing the conventional relationship between the transition of excess water amount in the body of the dialysis patient and the dialysis treatment.

### DESCRIPTION OF THE EMBODIMENTS

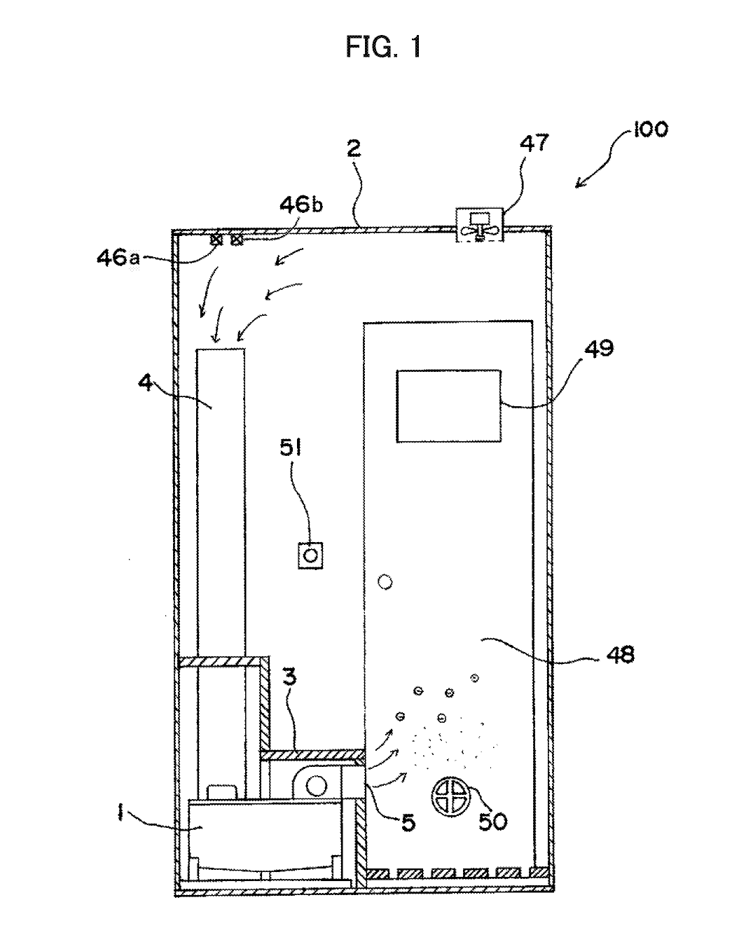

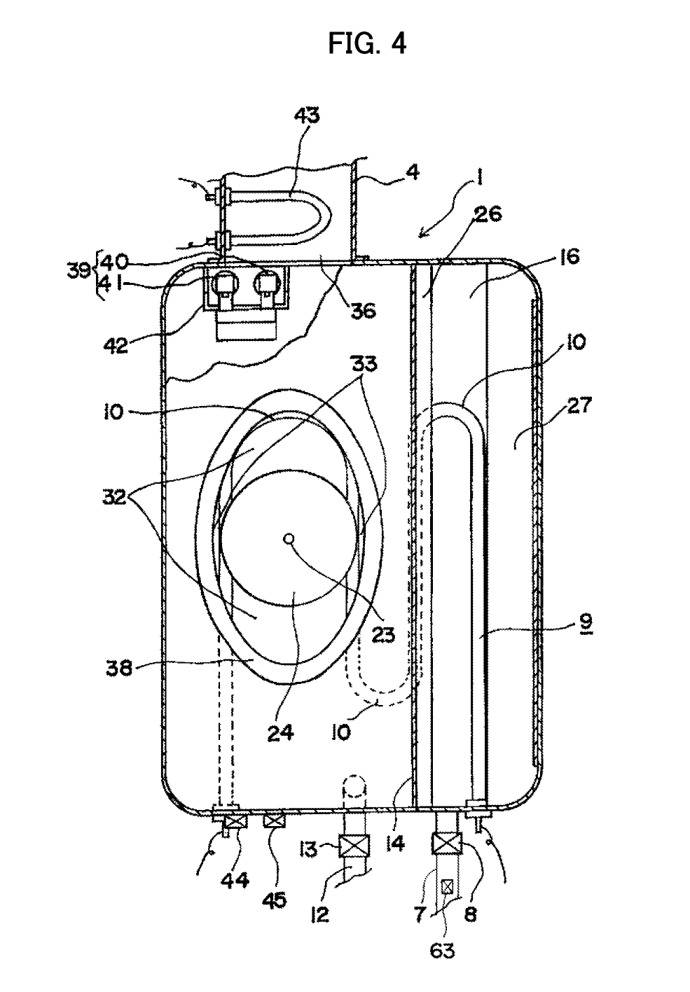

A configuration of the apparatus for promoting ineffective sweating 100 according to the embodiment of the present invention will be described in detail with reference to FIG. 1 to FIG. 5 appropriately.

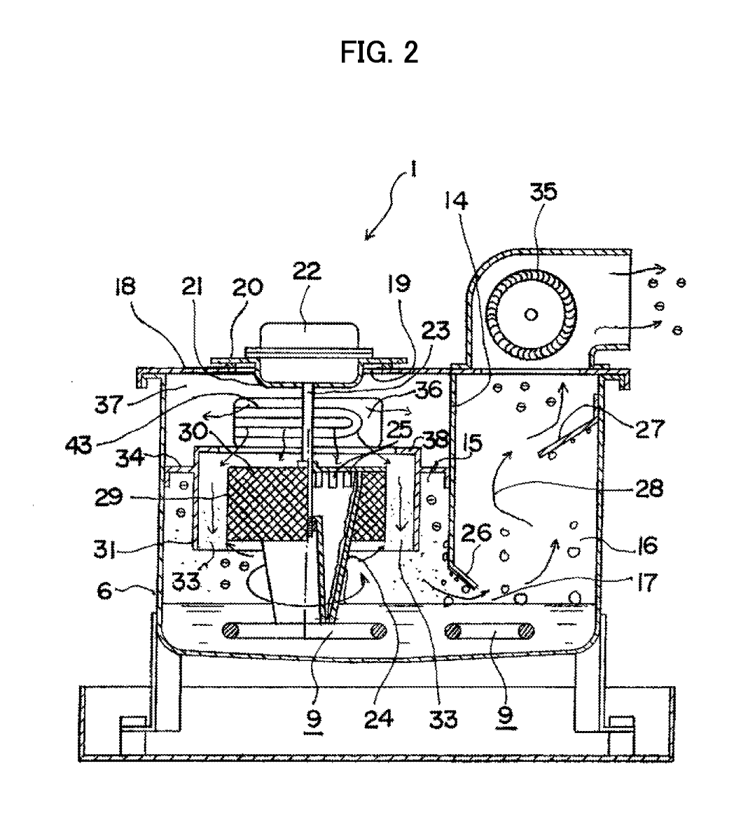

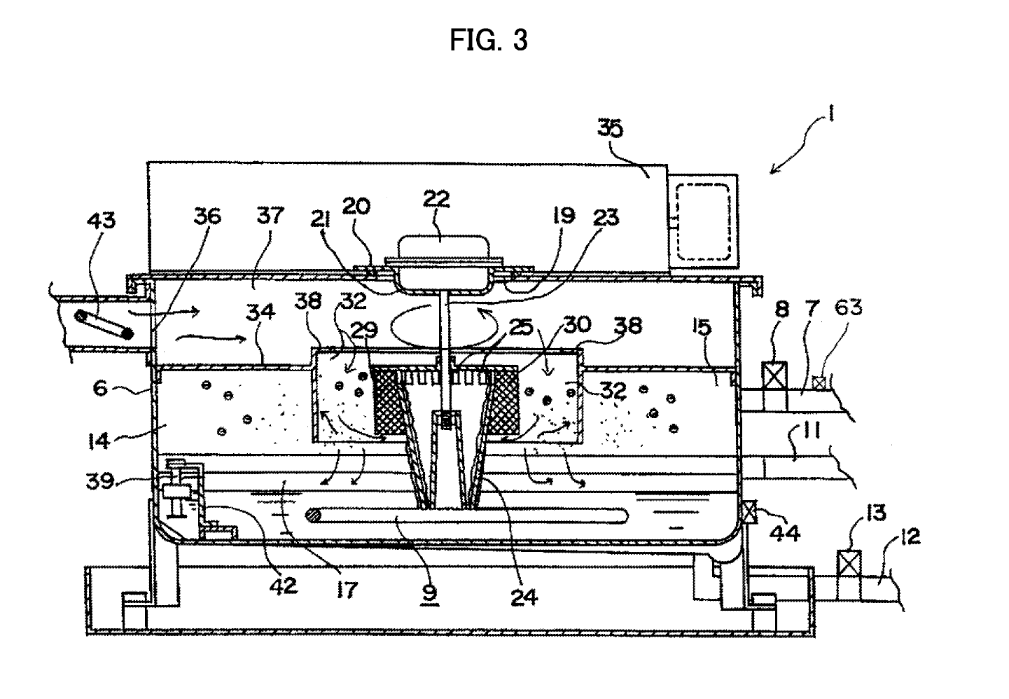

The apparatus for promoting ineffective sweating 100 includes, as shown in FIG. 1, a low temperature sweating room 2, a mist generator 1 installed under a bench 3 of the sweating room 2 for generating nano-mist (referred to as “mist” hereinafter) including fine droplet and negative air ions, a temperature sensor 46a for measuring the room temperature in the sweating room 2, a humidity sensor 46b for measuring the relative humidity in the sweating room 2, an air heater 43 which is an air heating means for heating the air in the sweating room 2 (see FIG. 3), a blower 35 (see FIG. 2) for circulating the air in the sweating room 2 by supplying the mist in the sweating room 2 (see FIG. 2), and a control device 61 for controlling the operation.

The apparatus for promoting ineffective sweating 100 sucks the air in the sweating room 2 through a suction duct 4 extending to the upper part in the sweating room. 2, and removes dust and germ, subsequently supplies the fine droplet and the negative air ions to the sweating room 2 from a discharge port 5 formed below the bench 3 to humidify the air in the sweating room 2. This process is repeated sequentially to cause the air in the sweating room 2 to circulate so as to control the sweating room 2 to be an ineffective sweating environment in which room temperature for use is in a range from 37 to 42 degrees C. and the relative humidity is 90% or more.

<Mist Generator>

The mist generator 1 will be described based on FIG. 2 to FIG. 4. The mist generator 1 is a device for humidifying the inside of the sweating room 2 by generating the nano-mist including the negative air ions.

The mist generator 1 includes, as shown in FIG. 2 and FIG. 3, a water storage unit 6 for storing a certain amount of water, a water supply pipe 7 connected to one side wall of the water storage unit 6 for supplying water to the water storage unit 6, an automatic water supply valve 8 provided in a middle of the water supply pipe 7 for opening and closing the water supply pipe 7, a heater 9 installed horizontally in M-shaped in a plane vision in the vicinity of the bottom part of the water storage unit 6 below the water surface of the water storage unit 6 with single phase 200V and 2 KW and provided with three U-shaped parts 10 for heating the water stored in the water storage unit 6, a overflow pipe 11 provided on one side wall of the water storage unit 6, a drainpipe 12 connected to the bottom part of the water storage unit 6 for draining the water stored in the water storage unit 6 or the heated water heated by the heater 9, an automatic drain valve 13 disposed in a middle of the drainpipe 12 for opening and closing the drainpipe 12, and a partition wall 14 for partitioning the inside of the water storage unit 6 into two rooms of a processing room 15 and a separating room 16.

The partition wall 14 is formed by bending a lower end to a side of the separating room 16 lowering a communication passage 17 between the water surface and the partition wall 14 close to the water surface so as to serve as a gas and liquid separator for causing large drops of mist (droplet) in the air flowing from the processing room 15 to the separating room 16 to hit against the water surface and fall.

In the processing room 15, a lower half part of the motor for rotation 22 is housed in a concave part 21 of a waterproof cover 20, and inserted into a insertion hole 19 provided on a lid body 18 of the water storage unit 6, and the motor for rotation 22 and a spindle 23 are coupled, a rotation body 24 formed in a conical shape with a lower part submerged and a diameter gradually expanded toward upward is hung in the U-shaped part 10 furthest from the water supply pipe 7 of the heater 9, wherein the rotation body 24 is rotate by being driven by the motor for rotation 22 to suck warm water in the water storage unit 6 heated by the heater 9 along a front surface and rather a rear surface of the rotation body 24 by the centrifugal force and to scatter the warm water around from a plurality of fine holes 25 formed on the upper end of the rotation body 24.

In the separating room 16, a first baffle plate 26 formed by bending the lower end of the partition wall 14 downward of the separation room 16 and a second baffle plate 27 attached to a side wall facing the partition wall 14 while being inclined downward are projected alternately so that a serpentine passage 28 heading from the communication passage 17 in the lower part to a discharge port 5 in the upper part is formed in the center part.

A cylindrical porous body 29 is disposed in the outer periphery of the rotation body 24.

The porous body 29 is located with a predetermined interval kept relative to the rotation body 24, and is rotated together with the rotation body 24.

The mist generator 1 is intended to pump up the water in the water storage unit 6 by the centrifugal force generated by rotation of the rotation body 24 and scatter the air, and intended to cause the water to pass through and hit against the porous unit 30 composed of a number of slits, wire nets, and punching metals or the like formed on a full peripheral wall of the porous body 29 so as to generate the fine droplets in nano meter (nm) size, and also, so as to generate negative air ions by utilizing Lenard's effect obtained by miniaturization of the water particles, wherein a water crush unit is constituted by the motor for rotation 22 for rotating the rotation body 24, the rotation body 24, and the porous body 29 rotating together with the rotation body 24.

An air guide cylinder 31 having an elliptical shape is disposed in the outer periphery of the porous body 29.

The air guide cylinder 31 is disposed so as to cover the porous body 29 with a predetermined distance kept relative to the porous body 29. The air guide cylinder 31 is provided with an inner lid 34 for closing an upper part of the processing room 15 so that a pair of wide flow paths 32 and a pair of narrow flow paths 33 are formed between the air guide cylinder 31 and the cylindrical porous body 29.

The mist generator 1 is intended to cause the air in the sweating room 2 sucked from an air supply port 36 between the lid body 18 and an inner lid 34 through the suction duct 4 by being driven by the blower 35 mounted at a position communicating the separation room 16 and the discharge port 5 (see FIG. 1) above the separation room 16 into an air supply room 37 which has an air supply port 36 with the suction duct 4 connected to one side wall of the air supply port 36 and is formed by a space between the lid body 18 and the inner lid 34, and further intended to cause the air to flow from the upper part of the rotation body 24 into the air guide cylinder 31 towards the processing room 15 from the air supply room 37 above the processing room 15 so as to increase the number of crushing the water particles and increase the negative charging of the air, and resulting in being capable of generating a large amount of the fine droplets in nano meter size and negative air ions, for example, in case of the negative air ions, in detecting approximately a quantity of seven thousand ions/cc at a middle position of a center part of the sweating room 2. Additionally, the blower 35 is a cross flow fan in which rotation speed is varied, and is capable of performing a high-power operation with a higher rotational frequency and a low-power operation with a low rotational frequency.

The air guide cylinder 31 is provided with a flange unit 38 protruding inward in the inner periphery, the flange unit 38 being located above the upper surface of the rotation body 24 in order to prevent the water which is pumped up from the water storage unit 6 by the centrifugal force generated by the rotation of the rotation body 24 and is scattered through the porous body 29 and is splashed back from the air guide cylinder 31 from scattering to unintended places, for example, in the vicinity of a connection part between the motor for rotation 22 fixed on the lid body 18 and the spindle 23, and in the air supply room 37.

A water level detection unit 39 includes two float switches 40 and 41 provided in the bottom part of the water storage unit 6 for outputting a detection signal when there is water or warm water in the water storage unit 6. The float switch 40 is intended to detect a low water level of the water stored in the water storage unit 6, and outputs the detection signal when there is the water below a predetermined water level at which the heater 9 is not exposed above a water surface. The float switch 41 detects a high water level of the water stored in the water storage unit 6. The float switch 40 outputs the detection signal when the water reaches a predetermined water level (high water level) which is kept higher than the water level at which water (low water level) is detected by the float switch 40.

In other words, when the water level of the water storage 6 is lowered to the predetermined water level (low water level) at which the heater 9 is not exposed above the water surface, the float switch 40 for detecting the low water level is turned off so that the automatic water supply valve 8 is opened, and that water is supplied to a fixed water level. Subsequently, when the water in the water storage unit 6 reaches the predetermined water level (high water level) , and the float switch 40 for detecting the high water level is turned on so that the automatic water supply valve 8 is closed. Thus, the water level detection unit 39 is intended to constantly keep the water in the water storage unit 6 within a range of the predetermined water levels during operation of the apparatus for promoting ineffective sweating 100.

The two float switches 40 and 41 are provided with a protection frame 42 of a channel shape for protecting themselves not to be influenced by fluctuation of the water surface of the water storage unit 6. The protection frames 42 are formed as a frame body with front faces and both sides protruded above the water surface, surround the two float switches 40 and 41 with the one side wall of the water supply unit 6, and hung and fix the two float switches 40 and 41 on the upper surfaces.

An air heater 43 is an air heating unit of U-shaped attached to the air supply port 36 constituting an air supply passage with the suction duct 4 and operated at 100V and 340 W, the air heater 43 being protruded from a side wall of the air supply port 36 and being inclined with an upper part laid a little rearward against the side wall, being disposed so as to efficiently contact with air flowing from inside the sweating room 2 with the U-shape part of the heater not overlapped and in small faces to heat the air from inside the sweating room 2, driving the blower 35 in starting operation of the apparatus for promoting ineffective sweating 100 and also being powered to heat air to be circulated in the sweating room 2 and to raise an atmospheric temperature in the sweating room 2 so that a rise time is intended to be shorten. Further, the air heater 43, after operation of the apparatus for promoting ineffective sweating 100 is finished, drives the blower 35 and also powers the air heater 43, and causes warm wind to dry inside the mist generator 1 so as to keep its hygienic condition in good condition.

The mist generator 1 includes a stored water temperature sensor 44 provided in a predetermined water level on the lower external wall of the water storage unit 6, and an overheat prevention sensor 45 provided in a predetermined water level on the lower external wall of the water storage unit 6. The stored water temperature sensor 44 is functioned as a stored water temperature detection unit for detecting a temperature in the stored water in the water storage unit 6. The overheat prevention sensor 45 is intended to secure safety by stopping all operation when the water storage unit 6 becomes in an abnormal overheat state.

<Temperature sensor and Humidity Sensor>

A temperature sensor 46a is a room temperature detection unit provided on the upper part in the sweating room 2 for detecting the room temperature in the sweating room 2. A humidity sensor 46b is a relative humidity detection unit provided on the upper part in the sweating room 2 for detecting the relative humidity in the sweating room 2.

<Sweating Room>

The apparatus for promoting ineffective sweating 100 includes a ventilator 47 for ventilating the sweating room 2, a door 48 for entering and exiting the sweating room 2, a sight glass 49 provided on the upper part of the door 48, an air inlet 50 provided on the lower part of the door 48 for taking in air from the outside of the sweating room 2 into the inside of the sweating room 2. The air inlet 50 is, when the ventilator 47 is driven, structured to be opened so that the air is supplied from the outside of the sweating room 2 into the inside of the sweating room 2.

The apparatus for promoting ineffective sweating 100 includes an emergency switch 51, and when an abnormality occurs to a user who is taking a bath in the sweating room 2, the emergency switch 51 is operated by the user to report the occurrence of the abnormality in the sweating room 2 to the outside of the sweating room 2 mainly by sounding a buzzer, and to cause the automatic drain valve 13 to open and drain warm water in the water storage unit 6, and also to operate the ventilator 47 so that temperature and humidity in the sweating room 2 are lowered and the inside of the sweating room 2 is returned to a normal state.

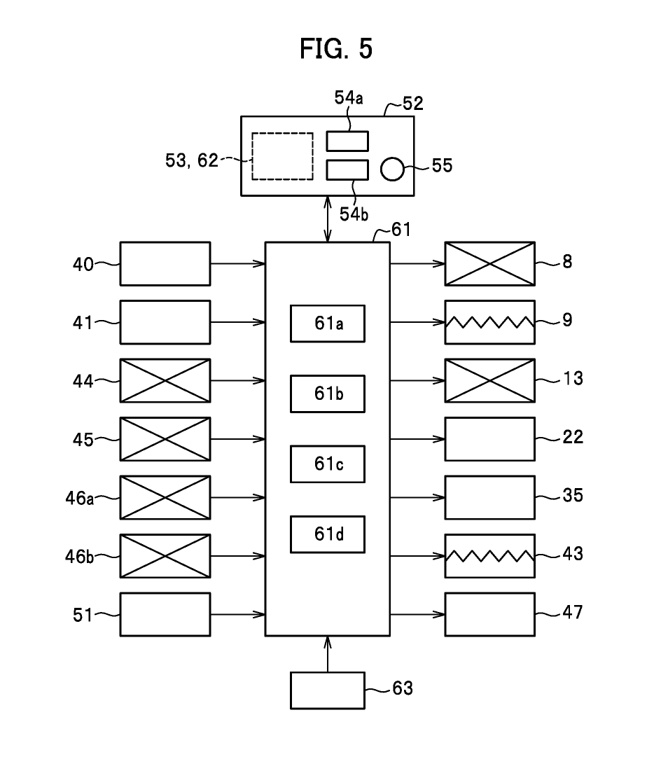

The apparatus for promoting ineffective sweating 100 includes a remote controller 52 (see FIG. 5) for remotely controlling the apparatus for promoting ineffective sweating 100, the remote controller 52 includes a room indoor preset temperature display unit 53 for displaying a room indoor preset temperature in the sweating room 2, a room indoor temperature display unit 54a for displaying the temperature in the sweating room 2 detected by the temperature sensor 46a, a humidity display unit 54b for displaying the relative humidity in the sweating room 2 detected by the humidity sensor 46b, a room temperature setting switch 55 for setting the preset temperature in the sweating room, for example, to be in a range from 37 to 42 degrees C. at an interval of 1 degree, an operation witch (not illustrated) for instructing start and stop of operation of the apparatus for promoting ineffective sweating 100, an operation lamp for displaying ON or OFF of the operation switch, a ventilation switch for driving the ventilator 47 to cause the ventilation 47 to perform a ventilation operation and the like in the sweating room 2, a ventilation lamp for displaying ON or OFF of the ventilation switch, and a bath lamp which is lighted by lighting when the temperature in the sweating room 2 reached the temperature preset by the room temperature setting switch to notify ready to enter the sweating room 2.

<Control Device>

A control device 61 is a control unit having functions such as storage, computing, and time counting or the like as shown in FIG. 5 for controlling operation of the apparatus for promoting ineffective sweating 100.

The control device 61 and the remote controller 52 are communicably connected by radio or wired network. The input side of the control device 61 is connected with the float switches 40 and 41, the stored water temperature sensor 44, the overheat prevention sensor 45, the temperature sensor 46a and the humidity sensor 46b, and the emergency switch 51, while the output side of the control device 61 is connected with the automatic water supply valve 8, the heater 9, the automatic drain valve 13, the motor for rotation 22, the blower 35, the air heater 43, and the ventilator 47.

The control device 61 includes a room temperature control unit 61a for controlling room temperature in the sweating room 2, a humidity control unit 61b for controlling the relative humidity in the sweating room 2, a dew-point temperature determination unit 61c for determining the dew-point temperature in the sweating room 2, and a body temperature setting unit 61 for setting the body temperature of the user.

The room temperature control unit 61a controls the air heater 43 so as to keep the room temperature in the sweating room 2.

The humidity control unit 61b controls a rotation speed of the motor for rotation 22 for rotating the rotation body 24 of the mist generator 1 and controls the air heater 9 for heating the warm water in the water storage unit 6 so as to keep the humidity in the sweating room 2. When the relative humidity is raised, the rotation speed of the motor for rotation 22 is increased and the temperature in warm water in the water storage unit 6 is raised.

The control device 61 controls the air heater 43 which is the air heating means and the mist generator 1 so that the dew-point temperature determined by the dew-point temperature determination unit 61a is kept higher than the body temperature of the user.

The dew-point temperature determination unit 61c determines the dew-point temperature in sweat diffused from the user in the sweating room 2 from a preset dew-point temperature calculation formula based on the room temperature in the sweating room 2 measured by the temperature sensor 46a and the relative humidity in the sweating room 2 measured by the humidity sensor 46b.

“Dew-point temperature” is a temperature at which the sweat of the user is not evaporated and formed as droplet, and the room temperature and the relative humidity are managed so as to be higher than the body temperature of the user so that ineffective sweating is promoted. The room temperature is prevented from being excessively increased with the low burden on the user.

Thus, it is preferable that the dew-point temperature is controlled, for example, within 4 degrees C. relative to the body temperature of the user. For example, when the body temperature of the user is 37 degrees C., the relative humidity is controlled so that the dew-point temperature is kept higher than 37 degrees C. and not exceeding 41 degrees C.

<Dew-Point Temperature Determination Unit>

The dew-point temperature td [°C.] of the sweating room 2 can be determined approximately from the dew-point temperature calculation formula (empirical formula), not especially limited because correction coefficients or the like are used based on various conditions, however, for example, the dew-point temperature determination unit determines the dew-point temperature td [° C.] in the sweating room 2 as follows.

When the temperature in the sweating room 2 is represented as t [° C.], an absolute temperature T[K] is determined by T=t+273.15. The relative temperature in the sweating room 2 is represented as RH [%].

A saturated water vapor pressure Pws [kPa] is determined by

Pws=exp{−5800.2206/T+1.3914993−0.048640239×T+0.000041764768×T²−0.000000014452093×T³+6.5459673×In(T)}10000

A water vapor pressure Pw[kPa] is determined by

Pw=Pws*×RH/100.

The dew-point temperature td [° C.] is determined by

td=237.3/{7.5/log(Pw/0.61078)−1}.

Specifically, when the room temperature in the sweating room 2 t[° C.] is set to be 39[° C.], T[K] is 312.5[K]. The relative humidity RH [%] is set to be 90 [%].

The saturated water vapor pressure Pws[kPa] is 6.998944 [kPa].

The water vapor pressure Pw[kPa] is 6.298869 [kPa].

The dew-point temperature td[° C.] is 37.07238 [° C.].

<Dew-Point Temperature Table>

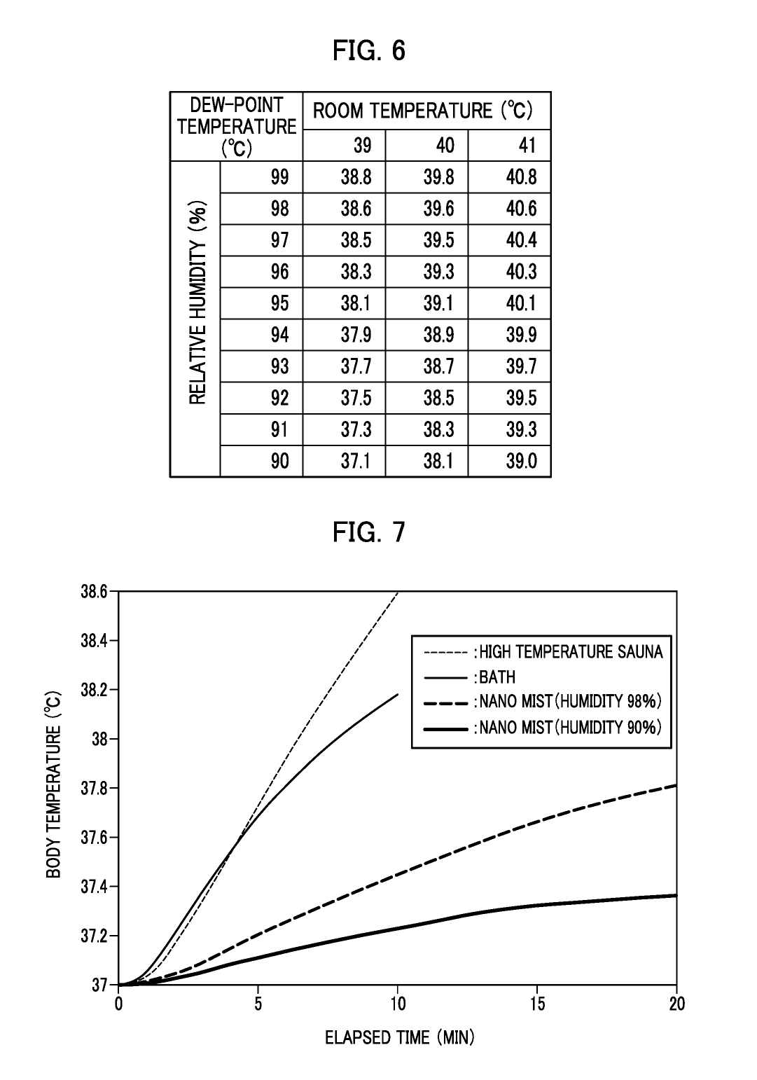

The dew-point temperatures determined as above are shown in FIG. 6 (a dew-point temperature table). As shown in FIG. 6, the dew-temperature td in the sweating room in which the temperature is 39 degrees C. and the relative humidity is 90 percentages is 37.1 degrees C.

Further, though in the present embodiment the dew-point temperature determination unit 61c determines the dew-point temperature td [° C.] in the sweating room 2 from the preset empirical formula, the dew-point temperatures can be stored as the dew-point temperature table (see FIG. 6) in a storage device.

Though a body temperature setting unit 61d can determine the body temperature of the user to be either a measured body temperature input by the user or a assumed body temperature preset by the user, the body temperature of the user maybe detected by a contact sensor (not shown) or a noncontact sensor (not shown) so that the body temperature of the user is determined.

When the user inputs one's body temperature as the measured body temperature from a remote controller 52 (see FIG. 5), the user can report while considering a state that the user has just finished a bath and the preset temperature in the sweating room 2. The assumed body temperature is not measured in such a way that the user inputs every time, but is stored previously as an initial setting.

The contact sensor (not shown) is a temperature detection unit for detecting the body temperature of the user in such a way as to be attached to the seat surface of the bench 3 (see FIG. 1) on which the user is seated and stuck to a body surface of the user. The noncontact sensor (not shown) is a temperature detection unit for irradiating infrared rays to the user to detect the body temperature of the user.

The operation of the apparatus for promoting ineffective sweating 100 configured in such a way according to the embodiment of the present invention and a method of taking a bath for using the apparatus for promoting ineffective sweating 100 to promote the ineffective sweating will be described mainly referring to FIG. 7 to FIG. 10.

In FIG. 7 to FIG. 10 to be referred, the ineffective sweating by the apparatus for promoting ineffective sweating 100 which generates nano-mist is represented as ineffective sweating or nano-mist as appropriate, and will be described while comparing with a high temperature sauna and bathing in hot water (represented as bath).

FIG. 7 is a graph for illustrating the effects of the apparatus for promoting ineffective sweating 100, in which the vertical axis indicates the body temperature of the user (° C.), and the horizontal axis indicates the elapsed time (min). The temperature in the sweating room 2 is 40 degrees C., and the relative humidity in the same is 90% and 98%.

The temperature in the sweating room 2 is the preset temperature that the user inputs by the room temperature setting switch 55 (see FIG. 5) according to one's preference, for example, in a range from 38 to 42 degrees C. The control device 61 controls the air heater 43 by a room temperature control unit 61a so as to keep the room temperature in the sweating room 2 to be the preset temperature (40 degrees C.) input by the user.

The apparatus for promoting ineffective sweating 100 causes the control device 61 to keep the relative humidity (90-98%) so that the dew-point temperature is, for example, within plus 4 degrees C., more preferably, within plus 2 degrees C. relative to the body temperature of the user based on the temperature (40 degrees C.) set by the user or the room temperature (40 degrees C.) measured by the temperature sensor 46a.

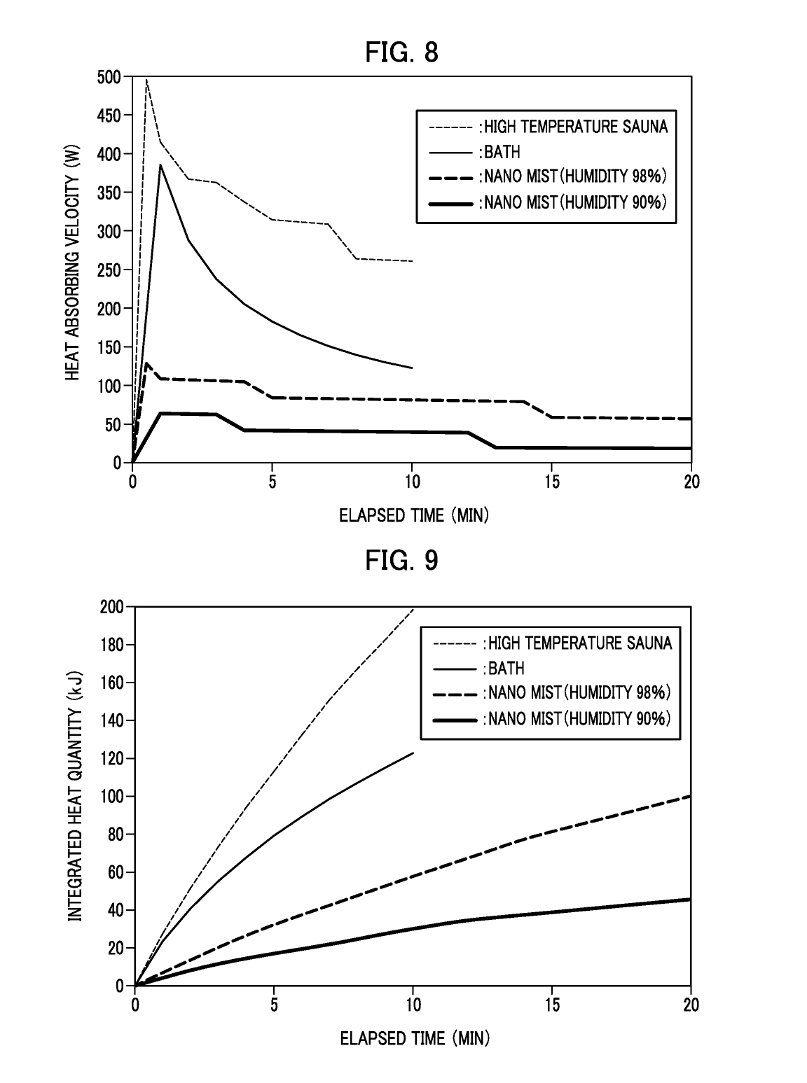

The temperature in the high temperature sauna to be compared is set to be 90 degrees C. and the relative humidity in the same is 10% (the dew-point temperature is 39.1 degrees C.), while a hot water temperature in the bath to be compared is 40 degrees C. FIG. 8 is a graph showing a progress of heat absorbing velocity (W) in FIG. 7. FIG. 9 is a graph showing a progress of integrated heat quantity (kJ) in FIG. 7.

As shown in FIG. 7, when the user is in the high temperature sauna and the bath, the body temperature rises suddenly after bathing, and after around 5 minutes passes, the body temperature rises to 37.7 degrees C., and the body temperature rises proportionally even afterwards. Accordingly, after 10 minutes passes, the body temperature rises to 38.6 degrees C. when the user is in the high temperature bath, and the body temperature rises to 38.2 degrees C. when the user is in the bath. When the user is in the high temperature sauna and the bathing, as shown in the progresses of the heat absorbing velocity (see FIG. 8) and the integrated heat quantity (see FIG. 9), the burden on the body of the user proves to be large.

When the user in the apparatus for promoting ineffective sweating 100, after 15 minutes passes, the body temperature of the user is around 37.6 degrees C. in a case where the relative humidity is 98%, while the body temperature of the user is around 37.3 degrees C. in a case where the relative humidity is 90%, thus, the burden on the body of the user proves to be small. At such a time, the dew-point temperature is 39.6 degrees C. (see FIG. 6) in a case where the relative humidity is 98%, while the dew-point temperature is 38.1 degrees C. (FIG. 6) in a case where relative humidity 90%, thus, reasonable ineffective sweating can be promoted by raising the body temperature moderately.

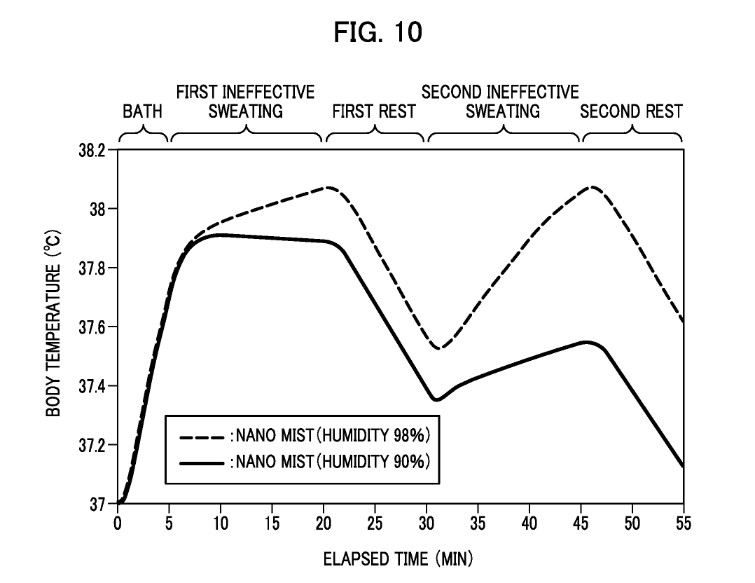

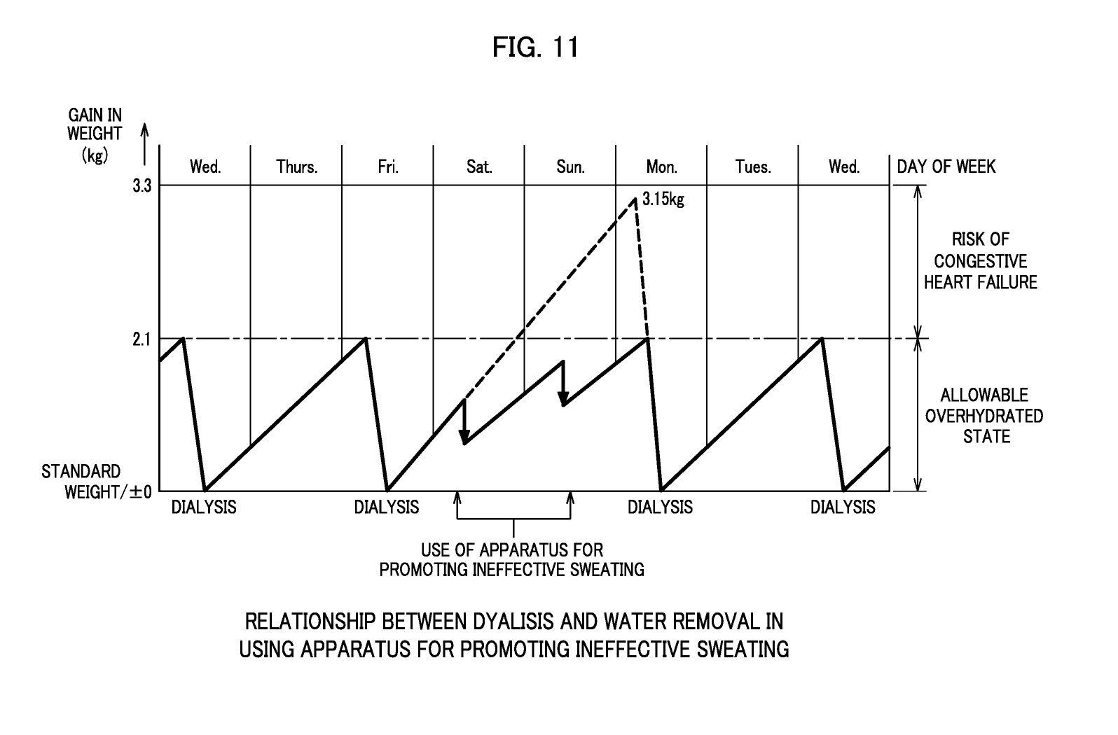

Subsequently, a method of taking a bath for promoting the ineffective sweating by using the apparatus for promoting ineffective sweating 100 will be described with reference to FIG. 10. In FIG. 10, the vertical axis indicates the body temperature of the user, and the horizontal axis indicates the elapsed time. As shown in FIG. 7, it is preferable to take a bath of around 40 degrees C. for 5 minutes (elapsed time: 0-5 minutes) before the sweating (low temperature nano-mist sweating) by using the apparatus for promoting ineffective sweating 100 for promoting the ineffective sweating.

When the user takes a bath for 5 minutes, a body surface temperature in the user rises to approximately 37.7 degrees C., thus it is assumed that pores are opened so that ineffective sweating by the low temperature nano-mist sweating is further promoted. However, it is confirmed that in taking a bath the body surface temperature rises, while no change of an internal body temperature 10 mm below the body surface is particularly observed.

Afterward, when the low temperature nano-mist sweating (room temperature: 40 degrees C., humidity: 90%) is promoted in the apparatus for promoting ineffective sweating 100 for 15 minutes (elapsed time: 5-20 minutes), the body surface temperature rises to around 37.9 degrees C. (elapsed time: 7 minutes) and then gradually falls to 37.8 degrees C. (elapsed time: 20minutes). This is because of a difference of a subject to be contacted which has been changed from fluid in taking a bath to gas of low temperature nano-mist. In case of the low temperature nano-mist sweating (room temperature: 40 degrees C., humidity: 90%), the dew-point temperature is 38.1 degrees C. (see FIG. 6), thus a difference from the body temperature is within 4 degrees C. (0.2-0.3 degrees C.), so that the ineffective sweating can be promoted reasonably.

In case of the low temperature nano-mist sweating (room temperature: 40 degrees C., humidity: 98%), the body surface temperature rises to 37.9 degrees C. (elapsed time: 7 minutes) and further rises to 38.1 degrees C. (elapsed time: 20 minutes). Under this condition, the dew-point temperature is 39.6 degrees C. (see FIG. 6), which is kept higher than the one in the case where the humidity is 90%, however a difference from the body temperature is within 4 degrees C. (1.5 to 1.7 degrees C.), so that even in this case it the ineffective sweating can be promoted reasonably.

It is preferable to take a rest for 10 minutes after the nano-mist sweating (elapsed time: 20-30 minutes). By taking a rest for 10 minutes, in case of the nano-mist sweating (room temperature: 40 degrees C., humidity: 90%), the body surface temperature falls from 37.9 degrees C. gradually to 37.3 degrees C. (elapsed time: 30 minutes), while in case of the nano-mist sweating (room temperature: 40 degrees C., humidity: 98%), the body surface temperature falls from 38.1 degrees C. gradually to 37.5 degrees C.

It is confirmed that the user is subject to the low temperature nano-mist sweating for 15 minutes and a rest for 10 minutes after taking a bath (bath) for 5 minutes so that weight loss is observed not only during the low temperature nano-mist sweating (temperature: 40 degrees C., humidity: 90.98%) but also during the rest for 10 minutes. For example, in case of a male who weighs 60 to 80s kg, the weight loss of 0.5 to 0.8 kg in total (amount to be 500 to 800 ml of sweating) is measured. Further, when a sweating amount is insufficient, the user can also be subject to the second ineffective sweating and the second rest.

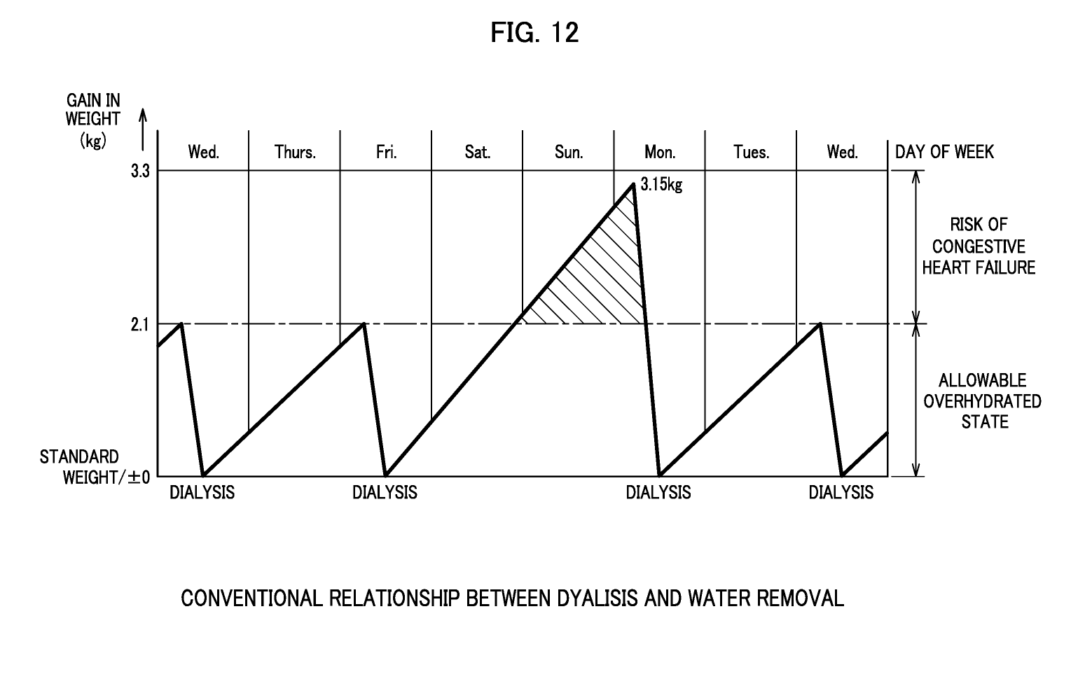

Specifically, as shown in FIG. 12, the weight increases to be 2.1 kg heavier (water amount: 2,100 ml) than the standard weight in case of every other day dialysis (dialysis interval: 42 hours) based on data. When the dialysis interval is every three days (dialysis interval: 66 hours), the weight increases by 3.15 kg (water amount: 3,150 ml), accordingly, the water amount increasing on Saturday and Sunday, namely, 3,150 ml-2,100 ml=1,050 ml (525 ml/day×2 days) can be evaporated by sweating by using the apparatus for promoting ineffective sweating 100 so that the overhydrated state is reduced more than the state incase of the every other day dialysis, resulting in increasing a possibility of avoiding a risk of suffering from the congestive heart failure.

In this way, when the dialysis patients are not subject to the dialysis treatment for two days (Saturday and Sunday), the low temperature nano-mist sweating for 1,050 ml is promoted for two days (Saturday and Sunday) so that it is possible to effectively prevent the dialysis patients from being reduced to the overhydrated state involving the risk of suffering from the congestive heart failure.

The apparatus for promoting ineffective sweating 100 operating as above provides the following working effects.

In other words, the apparatus for promoting ineffective sweating 100 according to the embodiment of the present invention can control the air heater 43 which is the air heating means and the mist generator 1 so that the dew-point temperature td determined by the dew-point temperature determination unit 61c is kept higher than the body temperature of the user so as to keep the dew-point temperature in the sweating room 2 to be a little higher than the body temperature, resulting in promoting the ineffective sweating with the low physical burden on the user.

Therefore, the apparatus for promoting ineffective sweating 100 is capable of promoting the comfortable ineffective sweating even for physically weak people such as the dialysis patients so as to prevent them from becoming the overhydrated state by regulating preferably the water amount in the body.

Though the embodiment of the present invention has been described as above, the present invention is not limited to the above embodiment, but can be varied appropriately to be performed. In the present embodiment, for example, the user is caused to take a bath before the low temperature nano-mist sweating by the apparatus for promoting ineffective sweating 100, however not limited to this, the present embodiment may include only the low temperature nano-mist sweating by the apparatus for promoting ineffective sweating 100.

Further, in the present embodiment, the air heater 43 is used for heating the air in the sweating room 2, however not limited to this, the air heater 43 can be used for drying after an end of the operation and also can be used as the air heating unit for controlling the room temperature in the sweating room 2 indirectly based on a mist temperature at which the heater 9 heats the stored water in the water storage unit 6.

### REFERENCE SIGNS LIST

1 Mist generator
2 Sweating room
3 Bench
4 Suction duct
5 Discharge port
6 Water storage unit
7 Water supply pipe
8 Automatic water supply valve
9 Heater
11 Overflow pipe
12 Drain pipe
13 Automatic drain valve
22 Motor for rotation
24 Rotation body
29 Porous body
35 Blower
43 Air heater
44 Stored water temperature sensor
46a Temperature sensor
46b Humidity sensor
55 Temperature setting switch
61 Control device
61a Room temperature control unit
61b Humidity control unit
61c Dew-point temperature determination unit
61d Body temperature setting unit
100 Apparatus for promoting ineffective sweating
td Dew-point temperature

1. An apparatus for promoting ineffective sweating comprising:
a sweating room for accommodating a user;
an air heating unit for heating air in the sweating room;
a mist generator for generating mist including negative air ions;
a blower configured to supply the mist in the sweating room to circulate the air in the sweating room;
a control device for controlling operation of the air heating unit and the mist generator;
a temperature sensor configured to measure a room temperature in the sweating room; and
a humidity sensor configured to measure a relative humidity in the sweating room, wherein
the control device comprises:
a dew-point temperature determination unit configured to determine a dew-point temperature in the sweating room based on the room temperature and the relative humidity; and
a body temperature setting unit configured to set a body temperature of the user, and wherein
the control device controls the air heating unit and the mist generator so that the dew-point temperature determined by the dew-point temperature determination unit is kept higher than the body temperature and that the relative humidity is in a range from 90 to 98%.

2. The apparatus for promoting ineffective sweating according to claim 1, wherein
the body temperature setting unit determines the body temperature of the user to be either a measured body temperature input by a user or a preset assumed body temperature.

3. The apparatus for promoting ineffective sweating according to claim 1, wherein
the control device controls the air heating unit to keep the room temperature equal to the preset temperature in a range from 37 to 42 degrees C. input by the user, and controls the mist generator to regulate the relative humidity in the sweating room based on the preset temperature so that the dew-point temperature is kept higher than the body temperature.

4. The apparatus for promoting ineffective sweating according to claim 1, wherein
the dew-point temperature unit determines the dew-point temperature from a dew-point temperature calculation formula and a dew-point temperature table, both of which being preset based on the room temperature and the relative humidity.

5. The apparatus for promoting ineffective sweating according to claim 1, wherein
the control device controls the air heating unit and the mist generator so that the dew-point temperature is kept higher than the body temperature and within a preset temperature difference.
